(19) United States
(12) Patent Application Publication
(10) Pub. No.: US 2026/0185367 A1
(43) Pub. Date: Jul. 2, 2026

(54) MULTI-NOZZLE AUTOMATED ADDITIVE SPRAYING AND METHODS OF ADDITIVE SPRAYING TO FORM CARBON DIOXIDE-INFUSED FIBER-REINFORCED CONCRETE

(71) Applicant: The Regents of The University of Michigan, Ann Arbor, MI (US)

(72) Inventor: Mania AGHAEI MEIBODI, Ann Arbor, MI (US)

(73) Assignee: The Regents of The University of Michigan, Ann Arbor, MI (US)

(21) Appl. No.: 19/131,472

(22) PCT Filed: Nov. 21, 2023
(86) PCT No.: PCT/US2023/080743

§ 371 Date: May 20, 2025

Related U.S. Application Data
(60) Provisional application No. 63/426,895, filed on Nov. 21, 2022.

(51) Int. Cl. E04G 21/04; B33Y 10/00; B33Y 30/00; B33Y 50/00; B33Y 70/10; C04B 28/04; C04B 40/02; C04B 111/00

(52) U.S. Cl. CPC E04G 21/04; B33Y 10/00; B33Y 30/00; B33Y 50/00; B33Y 70/10; C04B 28/04; C04B 40/0231; C04B 2111/00019; C04B 2111/00181

(57) ABSTRACT

Methods of additive manufacturing by spraying and automated spraying devices are provided. The device comprises a feed system and an automated spray head with at least one nozzle in communication with a first supply and a second supply to spray at least one stream comprising fibers and a sprayable cementitious material. A first nozzle may deliver the first sprayed stream comprising fibers, a second nozzle may deliver a second sprayed stream of first sprayable cementitious material, and a third nozzle may deliver a third sprayed stream of second sprayable cementitious material comprising carbon dioxide. The device forms a cementitious component on a target having a first region comprising a reinforced cementitious composite material. There is also a second distinct region comprising a carbonized cementitious material formed from the third sprayed stream comprising the second sprayable cementitious material comprising carbon dioxide.

### CROSS-REFERENCE TO RELATED APPLICATIONS

This application claims the benefit of U.S. Provisional Application No. 63/426,895, filed on Nov. 21, 2022. The entire disclosure of the above application is incorporated herein by reference.

### FIELD

The present disclosure relates to automated additive spraying with a sprayer device having at least three distinct nozzles for forming fiber-reinforced concrete having regions of carbon dioxide infusion made via additive manufacturing and automated spraying devices for the same.

### BACKGROUND

This section provides background information related to the present disclosure which is not necessarily prior art.

Traditional concrete construction can have certain drawbacks, including having high levels of waste, as well as being messy, time and labor-intensive, lacking precision, and accounting for approximately 8% of total global carbon dioxide emissions, of which 80% relates to cement production/manufacturing. Three-dimensional (3D) printing, also referred to as additive manufacturing (AM), of concrete offers novel opportunities to digitize the construction industry and significantly reduce its carbon dioxide (CO₂) footprint. Additive manufacturing (AM) or three-dimensional (3D) printing is a process by which material is applied in an additive, layer-by-layer formation technique. Additive manufacturing can form structures having highly complex geometries and freeform shapes and is of particular interest in the construction industry.

3D printing of cementitious materials, like concrete (concrete additive manufacturing or concrete three-dimensional printing-3DP (3DCP)) has the potential to significantly contribute to carbon neutrality by decreasing carbon dioxide (CO₂) emissions, energy consumption, waste, and costs associated with concrete construction, for example, by eliminating the need for formwork and minimizing concrete consumption in building structures. However, traditional extrusion-based 3D concrete printing has unresolved challenges inherent to its processes.

For example, the main drawback preventing typical extrusion-based 3D concrete printing from market integration is the technical challenge of integrating reinforcement for tensile property and weak layer bonding and the need for integrating reinforcements. While fiber reinforcement has been an alternative solution to replace rebars and increase layer bonding, the volume of fiber necessary poses processing challenges for extrusion-based methods due to the way it processes material. Other notable challenges include high shrinkage due to incompatibility with use of coarse aggregate and large exposure surfaces. Furthermore, design limitations inherent to extrusion printing constrain the full utilization of topologically optimized lightweight concrete elements that are further barriers to carbon neutrality. This has hampered the translation of 3D concrete printing to large-scale applications and restrained digitization in the concrete industry.

A new method of carbon-capture involves forming CO₂-infused concrete where CO₂ from the environment is integrated into concrete during mixing and forms calcium carbonate during the curing process, which permanently locks carbon within the concrete part. However, application of this technology has been limited to non-load bearing concrete blocks, because CO₂-infused concrete contributes to rebar corrosion (pH reductions in the chemistry of concrete due to carbonation leads to corrosion of the metal rebar). It would be advantageous to apply CO₂-infused concrete in regions with no rebar in structural concrete elements/structures. However, the typical fabrication methods for production of concrete structures, casting and even extrusion-based 3D printing, are not compatible for locally customizing the type of concrete to take advantage of CO₂-infused concrete in a concrete structure,

The present disclosure addresses the carbon neutrality barrier inherent to current concrete construction processes, by developing a new and economically competitive concrete additive manufacturing/3D printing technology and further providing the ability to infuse captured CO₂ permanently into the concrete structures that have load-bearing regions.

### SUMMARY

This section provides a general summary of the disclosure, and is not a comprehensive disclosure of its full scope or all of its features.

In certain aspects, the present disclosure relates to an automated spraying device for additive manufacturing. The device may comprise a feed system comprising a first supply line configured to deliver fibers, a second supply line configured to deliver a first sprayable cementitious material, and a third supply line configured to deliver a second sprayable cementitious material comprising carbon dioxide (CO₂). The device also includes an automated spray head that comprises: a first nozzle in communication with the first supply line, the first nozzle configured to deliver a first sprayed stream comprising fibers; a second nozzle in communication with the second supply line and configured to deliver a second sprayed stream comprising the first sprayable cementitious material, and a third nozzle in communication with the third supply line and configured to deliver a third sprayed stream comprising the second sprayable cementitious material comprising carbon dioxide (CO₂). The automated spraying system is configured to form a cementitious component on a target. The cementitious component has a first region comprising a reinforced cementitious composite material formed from the first sprayed stream comprising fibers from the first nozzle and the second sprayed stream comprising the first sprayable cementitious material. The cementitious component also has a second distinct region comprising a carbonized cementitious material formed from the third sprayed stream comprising the second sprayable cementitious material comprising carbon dioxide (CO₂).

In certain aspects, the second distinct region comprising the carbonized cementitious material is formed from the first sprayed stream comprising fibers from the first nozzle and the third sprayed stream comprising the second sprayable cementitious material comprising carbon dioxide (CO₂).

In certain aspects, the second distinct region of the cementitious component is free of any metal reinforcements.

In certain aspects, the first region of the cementitious component comprises at least one metal reinforcement.

In certain aspects, the automated spray head is disposed on at least one robotic device or a computer numerical control (CNC) gantry.

In certain aspects, the automated spray head is at least partially controlled by a computer numerical control (CNC) system.

In certain aspects, each of the first nozzle, the second nozzle, and the third nozzle are at least partially controlled individually by a computer numerical control (CNC) system.

In certain aspects, the first nozzle and the third nozzle are adjacent to one another on the automated spray head and the second nozzle is disposed at a predetermined distance away from the first nozzle and the third nozzle on the automated spray head.

In certain aspects, the first sprayed stream is a first pneumatically sprayed stream and the first supply line is pressurized and in fluid communication with a first compressed gas source, the second sprayed stream is a second pneumatically sprayed stream and the second supply line is pressurized and in fluid communication with a second compressed gas source, and the third sprayed stream is a third pneumatically sprayed stream and the third supply line is pressurized and in fluid communication with a third compressed gas source.

In certain aspects, the fibers are selected from the group consisting of: glass fibers, carbon fibers, plant-based fibers, animal-based fibers, and combinations thereof and the first sprayable cementitious material comprises a Portland cement, a fine aggregate, and water.

In certain aspects, the automated spraying device is configured to combine the first sprayed stream comprising fibers from the first nozzle and the second sprayed stream comprising the first sprayable cementitious material as a combined stream for deposition onto the target to the reinforced cementitious composite material in the first region.

In certain aspects, the automated spray head further comprises a fourth nozzle in communication with a fourth supply line, wherein the fourth nozzle is configured to deliver a fourth sprayed stream comprising solid particles.

In certain aspects, the feed system further comprises a fiber chopper that comprises a motor configured to chop a feed fiber into the fibers delivered in the first supply line to the first nozzle.

In certain other aspects, the present disclosure relates to a method of additive spraying of a cementitious material. The method may comprise spraying a first stream comprising fibers from a first nozzle on an automated spray head towards a target. The method may also comprise spraying a second stream comprising a first sprayable cementitious material from a second nozzle on the automated spray head towards the target. A first region of a cementitious component is formed on the target having a reinforced cementitious composite formed by the first stream and the second stream. The method also comprises spraying a third stream comprising a second sprayable cementitious material comprising carbon dioxide (CO₂) (that can form a CO₂ infused concrete) from a third nozzle on the automated spray head towards the target to form a second distinct region of the cementitious component on the target formed by the third stream and comprising a carbonized cementitious material.

In certain aspects, the spraying the first stream and the spraying of the second stream forms a first sprayed layer in the first region and the method further comprises repeating the spraying of the first stream and the second stream and forming at least one additional sprayed layer of reinforced cementitious composite over the first sprayed layer.

In certain aspects, the spraying the first stream and the second stream towards the target occur concurrently.

In certain aspects, the first stream and the second stream combine together and are deposited on the target as a combined stream.

In certain aspects, the spraying the first stream and the second stream towards the target occur sequentially to one another.

In certain aspects, the spraying the first stream occurs at a first flow rate for a first duration so that the fibers are present at a first concentration in the first region of the reinforced cementitious composite and the method further comprises adjusting the spraying of the first stream to a second flow rate distinct from the first flow rate for a second duration so that the fibers are present at a second concentration distinct from the first concentration in the first region of the reinforced cementitious composite.

In certain aspects, the fibers are selected from the group consisting of: glass fibers, carbon fibers, plant-based fibers, animal-based fibers, and combinations thereof and the first sprayable cementitious material comprises a Portland cement, a fine aggregate, and water.

In certain aspects, the second distinct region of the cementitious component comprising the carbonized cementitious material is formed by the spraying of the third stream and concurrently spraying of the first stream comprising fibers.

In certain aspects, the second distinct region of the cementitious component is free of any metal reinforcements.

In certain aspects, the first region of the cementitious component comprises at least one metal reinforcement, e.g., metal rebar reinforcement.

In certain aspects, the method further comprises spraying a fourth stream comprising solid particles from a fourth nozzle on the automated spray head towards the target, wherein the forming of the first region of reinforced composite material comprises combining the first stream, the second stream, and the fourth stream on the target.

In certain aspects, the target is a planar substrate.

In certain aspects, the target is a mold or form having a contoured surface.

In certain aspects, the target is a previously sprayed layer of reinforced cementitious composite.

In certain aspects, the method further comprises chopping a feed fiber into the fibers prior to the spraying the first stream comprising the fibers.

In certain further aspects, the present disclosure relates to an automated spraying device for additive manufacturing. The automated spraying device may comprise a feed system comprising a first supply configured to deliver fibers, a second supply configured to deliver a first sprayable cementitious material, and a third supply configured to deliver a second sprayable cementitious material comprising carbon dioxide (CO₂). The automated spraying device may also comprise an automated spray head that comprises at least one nozzle in communication with the first supply, the second supply, and/or the third supply. The at least one nozzle is configured to deliver at least one sprayed stream comprising the fibers, the first sprayable cementitious material, and/or the second sprayable cementitious material. The automated spraying system is configured to form a cementitious component on a target, the cementitious component has a first region comprising a reinforced cementitious composite material formed from the first sprayed stream comprising fibers and the second sprayed stream comprising the first sprayable cementitious material and a second distinct region comprising a carbonized cementitious material formed from the third sprayed stream comprising the second sprayable cementitious material comprising carbon dioxide (CO₂).

In certain aspects, the at least one nozzle includes a first nozzle, a second nozzle, and a third nozzle. The automated spray head comprises the first nozzle in communication with the first supply, the first nozzle configured to deliver a first sprayed stream comprising fibers. The automated spray head also comprises the second nozzle in communication with the second supply and configured to deliver a second sprayed stream comprising the first sprayable cementitious material. The automated spray head further comprises the third nozzle in communication with the third supply and configured to deliver a third sprayed stream comprising the second sprayable cementitious material comprising carbon dioxide (CO₂). The at least one sprayed stream further comprises a first sprayed stream, a second sprayed stream, and a third sprayed stream. The first nozzle is configured to deliver the first sprayed stream comprising fibers. The second nozzle is configured to deliver the second sprayed stream comprising the first sprayable cementitious material. The third nozzle is configured to deliver the third sprayed stream comprising the second sprayable cementitious material comprising carbon dioxide (CO₂). The cementitious component has the first region comprising a reinforced cementitious composite material formed from the first sprayed stream comprising fibers from the first nozzle and the second sprayed stream comprising the first sprayable cementitious material and the second distinct region comprising a carbonized cementitious material formed from the third sprayed stream comprising the second sprayable cementitious material comprising carbon dioxide (CO₂).

In certain further aspects, the first nozzle and the third nozzle are adjacent to one another on the automated spray head and the second nozzle is disposed at a predetermined distance away from the first nozzle and the third nozzle on the automated spray head.

In certain further aspects, the first sprayed stream is a first pneumatically sprayed stream and the first supply line is pressurized and in fluid communication with a first compressed gas source, the second sprayed stream is a second pneumatically sprayed stream and the second supply line is pressurized and in fluid communication with a second compressed gas source, and the third sprayed stream is a third pneumatically sprayed stream and the third supply line is pressurized and in fluid communication with a third compressed gas source.

In certain further aspects, the automated spray head further comprises a fourth nozzle in communication with a fourth supply line, wherein the fourth nozzle is configured to deliver a fourth sprayed stream comprising solid particles.

In certain further aspects, the automated spraying device is configured to combine the first sprayed stream comprising fibers from the first nozzle and the second sprayed stream comprising the first sprayable cementitious material as a combined stream for deposition onto the target to the reinforced cementitious composite material in the first region.

In certain further aspects, the second distinct region comprising the carbonized cementitious material is formed from the first sprayed stream comprising fibers from the first nozzle and the third sprayed stream comprising the second sprayable cementitious material comprising carbon dioxide (CO₂).

In certain aspects, the automated spray head further comprises a first chamber and a second chamber and the at least one nozzle defines a central region and a peripheral region, wherein the first chamber is in communication with the first supply and the central region of the at least one nozzle and the second chamber is in communication with the second supply and the peripheral region of the at least one nozzle.

In certain aspects, the feed system further comprises a fiber chopper that comprises a motor and is configured to chop a feed fiber into the fibers delivered in the first supply to the at least one nozzle.

In certain aspects, the automated spray head is disposed on at least one robotic device or a computer numerical control (CNC) gantry.

In certain aspects, the automated spray head is at least partially controlled by a computer numerical control (CNC) system.

In certain aspects, the at least one nozzle is at least partially controlled individually by a computer numerical control (CNC) system.

In certain aspects, the second distinct region of the cementitious component is free of any metal reinforcements.

In certain aspects, the first region of the cementitious component comprises at least one metal reinforcement.

In certain aspects, the fibers are selected from the group consisting of: glass fibers, carbon fibers, plant-based fibers, animal-based fibers, and combinations thereof and the first sprayable cementitious material comprises a Portland cement, a fine aggregate, and water.

In yet other aspects, the present disclosure relates to a method of additive spraying of a cementitious component. The method may comprise spraying at least one stream comprising fibers and a sprayable cementitious material from at least one outlet on an automated spray head towards a target. The method comprises forming a first region of the cementitious component on the target having a reinforced cementitious composite formed by the at least one stream. The method also comprises spraying an additional stream comprising a second sprayable cementitious material comprising carbon dioxide (CO₂) from an additional nozzle on the automated spray head towards the target to form a second distinct region of the cementitious component on the target formed by the additional stream and comprising a carbonized cementitious material.

In certain aspects, the spraying the at least one stream forms a first sprayed layer in the first region and the method further comprises repeating the spraying of the at least one stream and forming at least one additional sprayed layer of reinforced cementitious composite over the first sprayed layer.

In certain aspects, the at least one outlet comprises a first nozzle and a second nozzle and the spraying at least one stream further comprises:
spraying a first stream comprising fibers from the first nozzle on an automated spray head towards the target; and
spraying a second stream comprising the first sprayable cementitious material from the second nozzle on the automated spray head towards the target. The spraying of the first stream and the spraying of the second stream forms a first sprayed layer in the first region.

In certain further aspects, the spraying the first stream and the second stream towards the target occur concurrently.

In certain further aspects, the first stream and the second stream combine together and are deposited on the target as a combined stream.

In certain further aspects, the spraying the first stream and the second stream towards the target occur sequentially to one another.

In certain further aspects, the spraying the first stream occurs at a first flow rate for a first duration so that the fibers are present at a first concentration in the first region of the reinforced cementitious composite and the method further comprises adjusting the spraying of the first stream to a second flow rate distinct from the first flow rate for a second duration so that the fibers are present at a second concentration distinct from the first concentration in the first region of the reinforced cementitious composite.

In certain further aspects, the additional nozzle is a third nozzle and the second distinct region of the cementitious component comprising the carbonized cementitious material is formed by spraying a third stream comprising the second sprayable cementitious material comprising carbon dioxide (CO₂) from the third nozzle on the automated spray head towards the target to form the second distinct region of the cementitious component on the target.

In certain further aspects, the method comprises concurrently spraying of the first stream comprising fibers and the third stream.

In certain further aspects, the method further comprises spraying a fourth stream comprising solid particles from a fourth nozzle on the automated spray head towards the target, wherein the forming of the first region of reinforced composite material comprises combining the first stream, the second stream, and the fourth stream on the target.

In certain aspects, the fibers are selected from the group consisting of: glass fibers, carbon fibers, plant-based fibers, animal-based fibers, and combinations thereof and the first sprayable cementitious material comprises a Portland cement, a fine aggregate, and water.

In certain aspects, the second distinct region of the cementitious component is free of any metal reinforcements.

In certain aspects, the first region of the cementitious component comprises at least one metal reinforcement.

In certain aspects, the target is a planar substrate.

In certain aspects, the target is a mold or form having a contoured surface.

In certain aspects, the target is a previously sprayed layer of reinforced cementitious composite.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an automated spraying device prepared in accordance with certain aspects of the present disclosure and configured to conduct an additive spraying process by optionally generating a first sprayed stream comprising fibers from a first nozzle, a second sprayed stream comprising a first sprayable cementitious material from a second nozzle, and a third sprayed stream comprising a second sprayable cementitious material comprising carbon dioxide (CO₂) from a third nozzle directed towards a target on a planar substrate. In FIG. 1, the first and second nozzles are generating a first sprayed stream and a second sprayed stream, while the third nozzle is inactive during this operational mode.

FIG. 2 shows the automated spraying device of FIG. 1 being used to conduct an additive spraying process by generating a first sprayed stream comprising fibers from a first nozzle and a second sprayed stream comprising a sprayable cementitious material from a second nozzle directed towards a preform or mold having a contoured surface. Again, the first and second nozzles are generating the first sprayed stream and the second sprayed stream, while the third nozzle is inactive during this operational mode. The combined first sprayed stream and second sprayed stream form a conventional concrete mix that is applied to the load-bearing areas of a concrete structure being formed, where metal rebar reinforcement is necessary.

FIG. 3 shows an automated spraying device prepared in accordance with certain aspects of the present disclosure and configured to conduct an additive spraying process by optionally generating a first sprayed stream comprising fibers from a first nozzle and a third sprayed stream comprising a second sprayable cementitious material comprising carbon dioxide (CO₂) from a third nozzle directed towards a target that forms a non-load bearing thin shell of a cementitious component. Notably, a second nozzle that optionally generates a second sprayed stream comprising a first sprayable cementitious material from a second nozzle is inactive in FIG. 3 during this operational mode.

FIG. 4 shows the automated spraying device of FIG. 3 being used to conduct an additive spraying process by generating the first sprayed stream comprising fibers from the first nozzle and a second sprayed stream comprising a sprayable cementitious material from a second nozzle directed towards a target to form a load-bearing region of the cementitious component that has structural ribs with rebar reinforcements. The third nozzle is inactive during this operational mode.

FIG. 5 shows a perspective view of cementitious components in the form of lightweight slab segments using a rib and shell design with up to 75% material reduction that may be formed with first regions of reinforced cementitious composites having rebar reinforcements for load-bearing and second distinct regions of non-load bearing carbonized cementitious compositions in accordance with certain aspects of the present disclosure.

FIG. 6 shows another variation of an automated spraying device prepared in accordance with certain aspects of the present disclosure and configured to conduct an additive spraying process by concurrently generating a first sprayed stream comprising fibers optionally from a first nozzle that is generated by a fiber chopper component, a second sprayed stream comprising a sprayable cementitious material (or any other slurry material) from a second nozzle, and a third sprayed stream comprising a second sprayable cementitious material comprising carbon dioxide (CO₂) from a third nozzle directed towards a target on a planar substrate. In FIG. 6, the first and second nozzles are generating a first sprayed stream and a second sprayed stream, while the third nozzle is inactive during this operational mode.

FIG. 7 shows an automated spraying device prepared in accordance with certain aspects of the present disclosure and configured to conduct an additive spraying process capable of generating a concentric stream from a nozzle that includes a central region and a surrounding peripheral region, where the central region of the nozzle sprays fibers and the peripheral region sprays a sprayable cementitious material (or any other slurry material) or a second sprayable cementitious material comprising carbon dioxide (CO₂) towards a target on a planar substrate.

FIG. 8 shows an automated spray head that may be used with the automated spraying device in FIG. 7 prepared in accordance with certain aspects of the present disclosure where a feed system in the spray head has a fiber chopper component that generates the fibers for spraying in the central region of the nozzle and a slurry delivery system delivers a sprayable cementitious material (or any other slurry material) to the peripheral region of the nozzle to generate the concentric stream. The concentric stream is a pneumatically sprayed stream having a first pressurized supply line in fluid communication with a first compressed gas source and a second pressurized supply line is pressurized and in fluid communication with a second compressed gas source.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section, without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-Ray Disc).

The apparatuses and methods described in this application may be partially or fully implemented by a special purpose computer created by configuring a general purpose computer to execute one or more particular functions embodied in computer programs. Any functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides an alternative method of additive manufacturing from extrusion-based 3D printing of fiber-reinforced composites, such as fiber-reinforced concrete. The present disclosure contemplates an automated additive spraying process that can be done with robotics and other computer numerical control (CNC) driven machinery in certain variations. In certain aspects, the present disclosure provides an automated spraying device for additive manufacturing. The device has multiple distinct nozzles that generate distinct sprayed streams. In certain variations, two or more, optionally three or more nozzles may be used. All the nozzles may have a digitally variable and adjustable flow rate. In this manner, the automated spraying device is configured to deliver a first sprayable matrix material, such as a cementitious material, from at least one nozzle (e.g., a first nozzle). The cementitious material may be fiber-reinforced, will be described further below. The automated spraying device is also configured to deliver a second sprayable carbon-dioxide infused cementitious material from a distinct source, and optionally from a distinct nozzle, which may be fiber-reinforced, will be described further below

In this manner, the present disclosure provides a new method of additive manufacturing, which may be referred to as multi-nozzle (MN) Robotic Additive Spraying (RAS), which is an alternative to extrusion-based 3D printing. MN-RAS may be a robotic-controlled manufacturing process using compressed gas, such as compressed air, to spray various materials from independent nozzles in the spray device under pressure to fabricate concrete structures in layers and can overcome traditional challenges such as better interlayer bonding due to the high kinetic energy associated with pressurized material deposition in RAS. For example, fiber-reinforced carbon dioxide (CO₂)-infused concrete can be generated. The MN-RAS device may include at least one, optionally at least two, and in certain variations, at least three separate nozzles to 1) alternate between forming conventional concrete in load-bearing areas where rebar reinforcement is necessary to form a first concrete composition, and CO₂-infused concrete mixes present in regions of the concrete structure that are free of rebar or metal reinforcements. Carbonized concrete having infused carbon dioxide may otherwise enhance corrosion of metal in rebars or reinforcements (e.g., in iron-containing alloys, like steel). In this manner, manufactured concrete structures may have first regions having the first concrete composition that interfaces with metal reinforcements or rebar, while second regions are formed of carbon-infused or carbonized concrete compositions that are free of metal reinforcements or rebar. Further, the automated spraying permits the concurrent spraying of fiber reinforcements with the sprayed concrete compositions, for example, concurrently spraying carbon and glass fiber with either concrete composition (conventional first sprayable cementitious composition or the second carbonized/carbon-dioxide infused sprayable cementitious composition) for the enhanced tensile property.

In certain aspects, a method of additive spraying of a reinforced composite material includes spraying at least one stream comprising a reinforcement phase, such as fibers, and a sprayable slurry matrix material from at least one nozzle on an automated spray head towards a target. The at least one nozzle may be a single nozzle or two or more nozzles. In certain variations, the at least one stream may be a single sprayed stream, such as a concentric stream where a central region includes the fibers and a peripheral region that includes the sprayable slurry material. The at least one stream may also comprise two or more distinct sprayed streams, as described below. The method may also comprise forming a first sprayed layer of reinforced composite material from the at least one stream of the fibers and slurry matrix material on the target. The method further comprises repeating the spraying of the at least one stream forming at least one additional sprayed layer of reinforced composite material over the first sprayed layer.

Thus, in certain aspects, the methods may comprise concurrently spraying the a stream comprising fibers and the first sprayable cementitious material towards the target. The concurrently spraying may include spraying a first stream comprising fibers and a second stream comprising the first However, it will be appreciated that the present methods and devices may be used to form not only fiber-reinforced concrete with a cementitious matrix material as in the variations generally described herein, but alternatively can form other fiber-reinforced composites made of any kind of fiber (including plant-based fibers) with any matrix slurry that includes a powder (e.g., in additional to cementitious cement-based powders and supplementary cementitious materials, such as fly ash, flower-based materials, soil-based materials, clay, and the like) and granular material (such as sand, fines, and coats aggregate). However, in certain variations, the present disclosure contemplates the additive spraying of cementitious materials and fibers as generally discussed herein. It will be appreciated by that the discussion herein may more broadly apply to the alternative materials, as well. Notably, the CO₂-infused concrete generally includes at least one cementitious material that reacts with and binds carbon dioxide.

In certain variations, the first stream and the second stream may at least partially combine prior to hitting the target. In other aspects, the first stream and second stream may be directed in a manner such that their combination and mixing occurs on the target itself. In other variations, the methods may comprise successively spraying the first stream and then the second stream towards the target, thus forming a first layer from the first stream and a second layer over the first layer formed by the second stream. In certain other aspects, the methods may comprise spraying solely the second sprayable cementitious material comprising carbon dioxide (CO₂) towards the target. This forms a carbonized cementitious material that is free of fiber reinforcement. It should be noted that the second sprayable cementitious material comprising carbon dioxide (CO₂) is sprayed at a different region of the target than the second stream comprising the first sprayable cementitious material, so that different regions of the cementitious component formed on the target are defined by either first sprayable cementitious material or the second sprayable cementitious material comprising carbon dioxide (CO₂).

In other variations, the methods may include concurrently spraying the first stream comprising fibers and the third stream comprising the second sprayable cementitious material comprising carbon dioxide (CO₂) towards the target, so that the carbonized cementitious material has reinforcement fibers distributed therein. Again, the first stream and the third stream may at least partially combine prior to hitting the target. In other aspects, the first stream and third stream may be directed in a manner such that their combination and mixing occurs on the target itself. In other variations, the methods may comprise successively spraying the first stream and then the third stream towards the target, thus forming a first layer from the first stream and a second layer over the first layer formed by the second stream.

In certain other aspects, the methods of additive spraying may comprise spraying a fourth stream comprising an aggregate or granular material from an optional fourth nozzle on the automated spray head towards the target. The spraying of aggregate or solid particles from the fourth nozzle to form a fourth sprayed stream may occur instead of the spraying of the first stream comprising fibers or in combination with the first stream comprising fibers to provide a reinforcement phase to the composite material-either the conventional first sprayable cementitious composition or the second carbonized/carbon-dioxide infused sprayable cementitious composition. The fourth sprayed stream may introduce solid particles or aggregates into either the second stream comprising the first sprayable cementitious material or the third stream comprising the second sprayable cementitious material comprising carbon dioxide (CO₂).

In variations where the fourth stream is present, it may thus be concurrently sprayed with the first, second, or third streams towards the target and may at least partially combine with them prior to hitting the target. In other aspects, the first stream, the second stream, third stream, and optional fourth stream may be directed in a manner such that their combination and mixing occurs on the target itself. In other variations, the methods may comprise successively spraying the first stream, second stream, third stream, and optional fourth stream toward the target and forming a new layer over the subsequently applied layer.

In certain variations, the methods may comprise controlling and modifying a concentration of fibers present in the reinforced cementitious composite material and carbonized cementitious material formed over the target. For example, the spraying of the first stream may occur at a first flow rate for a first duration so that the fibers are present at a first concentration in the reinforced cementitious composite. The method may then further comprise adjusting the spraying of the first stream to a second flow rate distinct from the first flow rate for a second duration so that the fibers are present at a second concentration distinct from the first composition in the reinforced cementitious composite or carbonized cementitious material. This adjustment of fiber concentration may be done in a single sprayed layer or interspersed in different sprayed layers (where each layer may have a different concentration of fibers in the reinforced cementitious composite). Notably, the flow rates may be adjusted as needed and are not limited to only two flow rates, but may be highly variable, for example, adding higher concentrations of fibers for reinforcement in high stress areas of a structure, while providing lower concentrations of fibers in areas of a structure experiencing lower potential stress in service. In this manner, the methods of the present disclosure contemplate tailoring volume fraction fiber (VFF) in the reinforced cementitious composite and/or carbonized cementitious material and thus enables functional grading of the tensile property of the material. Further, as noted above, in certain regions, the carbonized cementitious material may be free of fiber reinforcements; while other regions may have fiber reinforcement, thus providing additional flexibility in the properties of the cementitious component formed.

In certain variations, the methods of additive spraying of a cementitious material may include spraying the first stream comprising fibers from a first nozzle on an automated spray head of a spray device towards a target and spraying the second stream comprising the first sprayable cementitious material from a second nozzle on the automated spray head towards the target. In this manner, a first region of a cementitious component is formed on the target having a reinforced cementitious composite formed by the first stream and the second stream. The methods may also include spraying the third stream comprising a second sprayable cementitious material comprising carbon dioxide (CO₂) from a third nozzle on the automated spray head towards the target to form a second distinct region of the cementitious component on the target formed by the third stream and comprising a carbonized cementitious material.

The methods may include repeating the spraying of the first stream and the second stream. Thus, in certain aspects, the spraying the first stream and the spraying of the second stream forms a first sprayed layer in the first region and the method further comprises repeating the spraying of the first stream and the second stream and forming at least one additional sprayed layer of reinforced cementitious composite over the first sprayed layer that is disposed on the target. In this manner, a physical structure of a cementitious component can be built in a flexible, automated, layer-by-layer additive manufacturing process without necessarily requiring traditional reinforcements (e.g., rebar) or extrusion. However, as noted above, the cementitious structure formed may in fact have the first region of the cementitious component that comprises at least one metal reinforcement, like rebar, that is formed by the reinforced cementitious composite with the first conventional cementitious material, whereas the second distinct region of the cementitious component formed of the carbonized cementitious material is free of any metal reinforcements. As such, the second distinct regions with carbonized cementitious material will not promote corrosion of any metal reinforcements, like rebar, which are present in the cementitious component, as they are isolated from those materials.

In certain other variations, where a fourth stream is generated by a fourth nozzle present on the automated spray head, the methods may comprise controlling and modifying a concentration of aggregate present in the reinforced cementitious composite material formed over the target. For example, the spraying of the fourth stream may occur at a first flow rate for a first duration so that the aggregate particles are present at a first concentration in the reinforced cementitious composite. The method may then further comprise adjusting the spraying of the fourth stream to a second flow rate distinct from the fourth flow rate for a second duration so that the aggregate particles are present at a second concentration distinct from the first composition in the reinforced cementitious composite. This adjustment of aggregate concentration may be done in a single sprayed layer or interspersed in different sprayed layers (where each layer may have a different concentration of granular particles or aggregates in the reinforced cementitious composite). Notably, the flow rates may be adjusted as needed and are not limited to only two flow rates, but may be highly variable, for example, adding higher concentrations of aggregate or granular particles in select areas of a structure, while providing lower concentrations of aggregate or granular particles in other areas of a structure. Further, the methods of the present disclosure may spray different particulate or granular materials, for example, successively spraying particles having diameters ranging from a fine particle size to a larger coarse particle size defining distinct layers with distinct particles sizes or a gradient of particle sizes within the reinforced cementitious composite. Similar to the additive spraying with the fibers, the methods allow for varying the size of the granules or aggregates in different regions of the reinforced cementitious composite. In this manner, the methods of the present disclosure allow the reduction of shrinkage and control of the resolution of the 3D printed parts.

In certain variations, the methods provided by the present disclosure may be referred to as Multi Nozzle Robotic Additive Spraying (MNRAS or RAS). RAS is a robotic-controlled manufacturing process that uses compressed gases, such as compressed air, to spray various materials from independent nozzles under pressure to fabricate concrete structures in layers. The additive manufacturing methods conducted in this manner can overcome traditional challenges such as better interlayer bonding, due to the high kinetic energy associated with pressurized material deposition from the streams in MNRAS. MNRAS uses at least two distinct nozzles to concurrently or simultaneously spray fibers, such as carbon and/or glass fibers, or alternatively or in addition, solid particles, with a flowable or liquid concrete material, for the enhanced tensile properties in at least certain regions of the formed cementitious component. Because MNRAS deposits carbon/glass fiber with wet mortar in successive layers from separate nozzles, it enables on-demand modulation of fiber amount (for example, tailoring volume fraction fiber (VFF)) and thus enables functional grading of the tensile property.

Moreover, the MNRAS methods and additive spraying device is versatile. As materials are deposited from separate nozzles, it is contemplated that an increased number of nozzles may be used in the system, for example, permitting depositing of aggregates (both fines and coarse) in addition to the depositing of carbon/glass fibers with wet mortar in successive layers from separate nozzles. The process enables on-demand modulation of fiber amount, aggregates, and motor concrete. For example, tailoring the size of the aggregates and thus enables high resolution surface finishing while keeping the strength needed for reducing cracks.

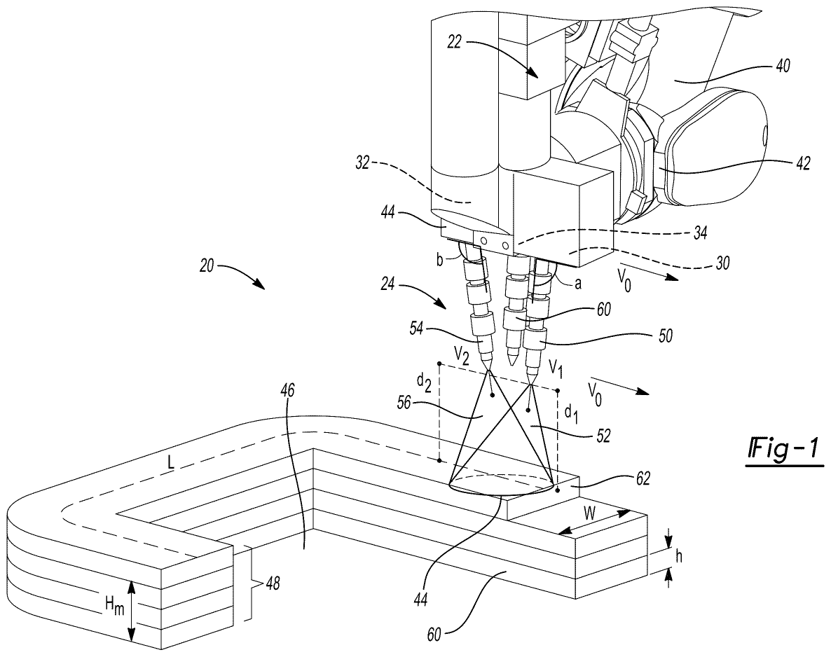

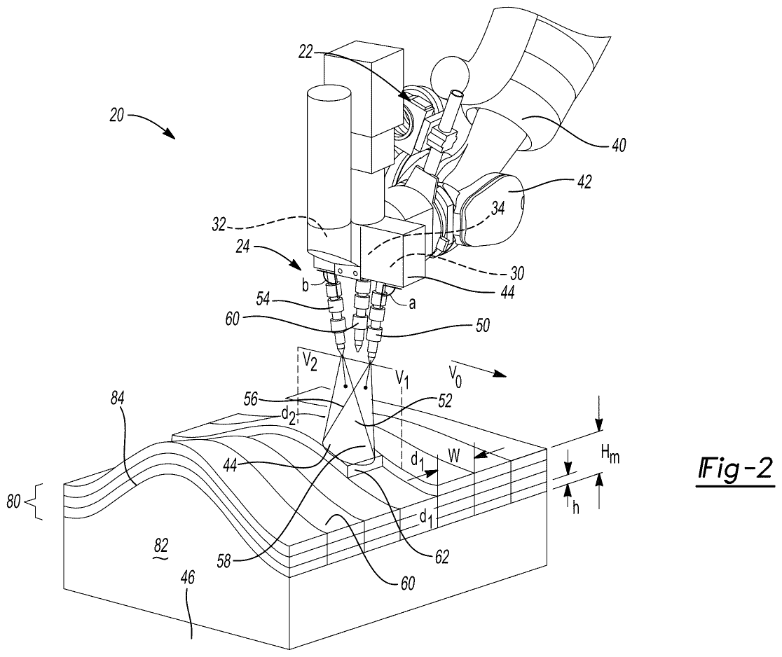

FIGS. 1 and 2 show an automated spraying device 20 for additive manufacturing. The device 20 comprises a feed system 22 and an automated spray system 24. The feed system 22 includes a first supply line 30 (disposed internally within the device 20) configured to deliver fibers. The feed system 22 also includes a second supply line 32 disposed internally within the device 20 that is configured to deliver a sprayable cementitious material (or in alternative variations, a low viscosity slurry) and a third supply line 34 disposed internally within the device 20 that is configured to deliver a sprayable second cementitious material comprising carbon dioxide (CO₂), which will be described further below.

While not shown in FIGS. 1 and 2, the first supply line 30 may be in fluid communication with a pressurized gas, such as a first compressed gas source, like compressed air, such that the compressed gas and fibers supplied by an upstream fiber supply are combined together in the first supply line 30 to create a first pressurized pneumatic spray stream described below. Likewise, the second supply line 32 may be in fluid communication with a pressurized gas, such as a second compressed gas source, like compressed air, such that the compressed gas and cementitious material supplied by an upstream cementitious material source combine together in the second supply line 32 to create a second pressurized pneumatic spray stream described below. The third supply line 34 may be in fluid communication with a pressurized gas, such as a third compressed gas source, like compressed air, such that the compressed gas and cementitious material supplied by an upstream cementitious material source combine together in the third supply line 34 to create a third pressurized pneumatic spray stream described below. Notably, the first, second, and third compressed gas sources may be the same or different from one another. While not shown, as appreciated by those of skill in the art, the automated spray system 24 may also include fourth nozzle connected to a fourth supply line to deliver solid particles in a fourth stream, similar to the first supply line that generates the first stream.

The automated spray system 24 includes an automated spray head 36, which may be digitally controlled. The automated spray head 36 is connected to a robotic arm 40 that has one or more actuators 42 and is connected to at least one controller (not shown) for translating the automated spray head 36 with respect to a target 44 disposed on a substrate 46 on which an additively manufactured fiber-reinforced cementitious composite component structure 48 is being built. In certain aspects, the automated spray system 24 may be part of a robotic device, such as a computer numerical control (CNC) machine, with a tiltable spray head 36 having specially designed nozzles that form the multilayered additively manufactured fiber-reinforced cementitious composite structure 48. Such machines have automation with advanced CNC machinery and highly articulated degrees of customization in directionality. The CNC machinery may include a computer processing unit (CPU) and one or more controllers that may be operated with various modules, as appreciated by those of skill in the art. Thus, an overall additive manufacturing system may comprises a CNC or robotic controlled automated spray system 24 that includes the automated spray head 36, which synchronously deposits a cementitious fiber-reinforced material from two distinct nozzles in the spray head in subsequent layers to form a monolithic solid structure. In certain aspects, the monolithic solid formed comprises at least one wall. The layers can be variable in thickness (e.g., height of each respective deposited layer), as controlled by the change in height between layers combined with the rate of spraying.

Notably, FIG. 1 shows the substrate being a flat planar surface, like the ground or a floor structure. While FIGS. 1 and 2, show vertical 3D spraying, while not shown, the processes and devices described herein can also be used for nonplanar spraying and nonvertical spraying, for example, horizontally 3D spraying on an existing wall.

The automated spray head 36 includes a first nozzle 50 in communication with the first supply line 30. The first nozzle 50 is configured to deliver a first sprayed stream 52 comprising fibers directed towards the target 44. The first nozzle 50 may be digitally controlled. The automated spray head 36 also includes a second nozzle 54 that is in communication with the second supply line 32 and is configured to deliver a second sprayed stream 56 comprising a first sprayable cementitious material towards the target 44. The second nozzle 54 may also be digitally controlled.

The automated spray head 36 includes a third nozzle 60 in communication with the third supply line 34. The third nozzle 60 is configured to deliver a third sprayed stream (not shown) comprising a second sprayable cementitious material comprising carbon dioxide (CO₂) that directed towards the target 44. The third nozzle 60 may be digitally controlled. It should be noted that in a first operational mode, the second nozzle 54 delivers a second sprayed stream 56 comprising a first sprayable cementitious material towards the target 44 while the third nozzle 60 is inactive as shown in FIGS. 1 and 2, whereas in a second operational mode, the second nozzle 54 is inactive, while the third nozzle 60 generates a third sprayed stream comprising the second sprayable cementitious material comprising carbon dioxide (CO₂) directed towards the target 44.

As shown in FIGS. 1 and 2, the first nozzle 50 and the third nozzle 60 are near or adjacent to one another on the automated spray head 36 and the second nozzle 54 is disposed at a predetermined distance away from the first and second nozzles 50, 60 on the automated spray head 36. The first and second nozzles, 50, 54 can be oriented in the automated spraying device/system 20, 24 so that the first sprayed stream 52 comprising fibers from the first nozzle 50 and the second sprayed stream 56 comprising the first sprayable cementitious material from the second nozzle 54 are combined and mixed together to form a combined stream 58. The combined stream 58 includes both the fibers and the first sprayable cementitious material and is thus deposited on target 44 as a top layer 62 of the multilayered additively manufactured fiber-reinforced cementitious composite structure 48 being formed on the substrate 46.

An additive spraying process in accordance with certain aspects of the present disclosure can be conducted on the automated spraying device 20 with a concrete and fiber sprayed from the two separate nozzles, first nozzle 50 and second nozzle 54. The digitally controlled automated spray head 36 moves at the velocity “V₀,” where each respective first nozzle 50 and second nozzle 54 has a distances of “d₁” and “d₂” from the successfully printed layer (e.g., uppermost top layer 62) and with the angles of “a” and “b” with respect to the automated spray head 36. The first nozzle 50 is spraying fiber at the velocity “V₁,” and the second nozzle 54 is spraying the cementitious mortar at velocity “V₂.” In this manner, distinct layers of individually selected height “h,” and width “w” can be formed. The overall height (Hₘ) of the cementitious composite component structure 48 can thus be the number of counter lengths multiplied by one height. When the third nozzle 60 is active and delivering a third sprayed stream, the second nozzle 54 is inactive, so that only second sprayable cementitious material comprising carbon dioxide (CO₂) is directed towards the target 44. In this operational mode, the first nozzle 50 may be either inactive or active and thus potentially co-spraying fibers via the first sprayed stream 52 with the third sprayed stream (not shown), but generated by third nozzle 60.

FIG. 2 shows the same automated spraying device 20 but being used to form an additively manufactured fiber-reinforced cementitious composite structure 80 on a mold or form 82, which may have a shaped, non-planar, and/or contoured surface 84. Thus, the target 44 is disposed on the contoured surface 84. In this manner, the first nozzle 50, the second nozzle 54, and/or third nozzle 60 may be controlled to deposit the sprayed layers of reinforced cementitious composite material and/or carbonized cementitious material at varying angles that change with position of the automated spray head 36 as it passes over the contoured surface 84.

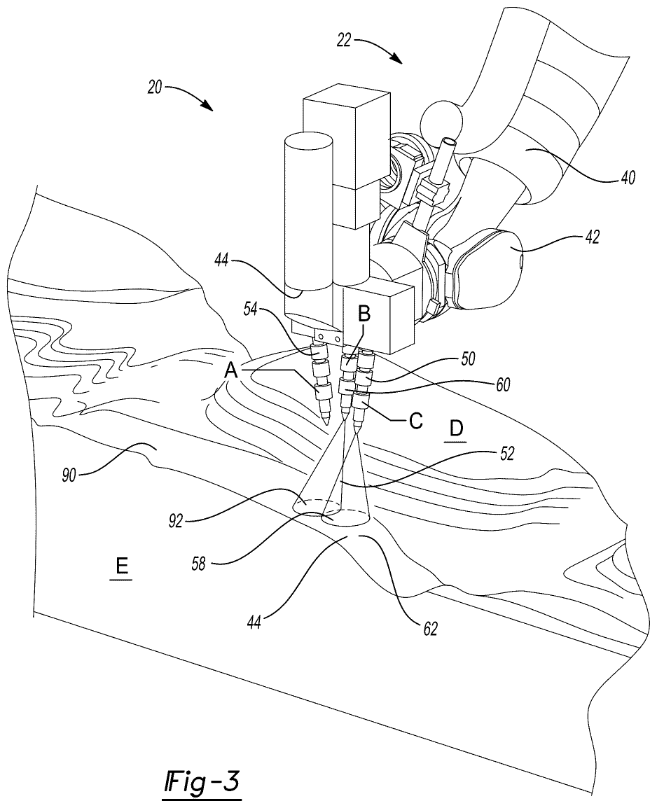

FIG. 3 shows the automated spraying device 20 being used to form a portion of an additively manufactured cementitious component structure 90 that is a non-load bearing thin shell. In FIG. 3, the automated spraying device 20 generates the first sprayed stream comprising fibers 52 ejected from the first nozzle 50. Further, a third sprayed stream 92 comprising a second sprayable cementitious material comprising carbon dioxide (CO₂) is ejected from the third nozzle 60 and is directed towards the target 44 that forms a non-load bearing thin shell of the cementitious component structure 90. Notably, the second nozzle 54 that optionally generates the second sprayed stream 56 shown in FIGS. 1 and 2 is inactive in FIG. 3 during this operational mode.

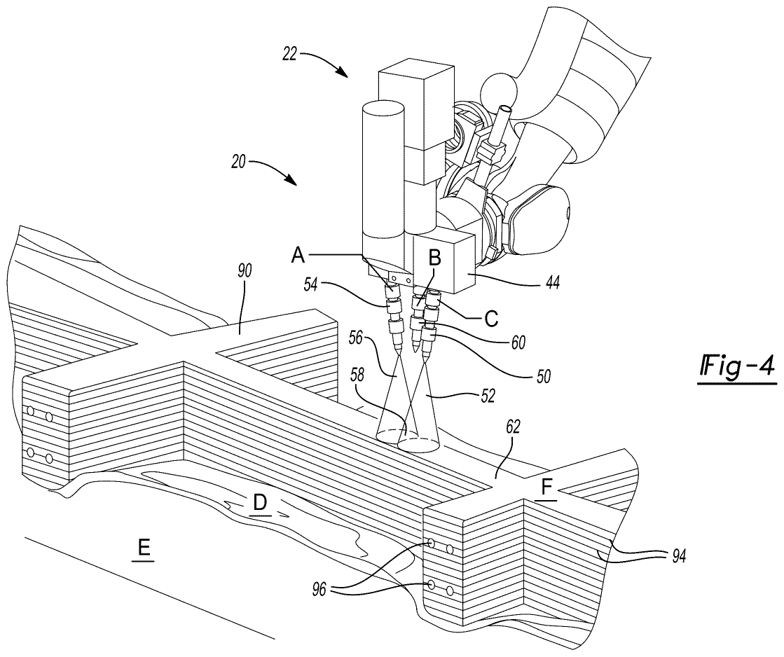

FIG. 4 shows the automated spraying device 20 being used to form a distinct portion of the additively manufactured cementitious component structure 90 that is load-load bearing. The substrate 44 has structural ribs 94 with rebar reinforcements 96. In this manner, the automated spraying device 20 generates the first sprayed stream 52 comprising fibers ejected from the first nozzle 50. Further, the second sprayed stream 56 comprising the first sprayable cementitious material is directed towards the target 44 where it surrounds and embeds the structural ribs 94. This forms a load-bearing region of the cementitious component structure 90 having integrated and embedded structural ribs 94/metal reinforcements 96. The third nozzle 60 is inactive during this operational mode

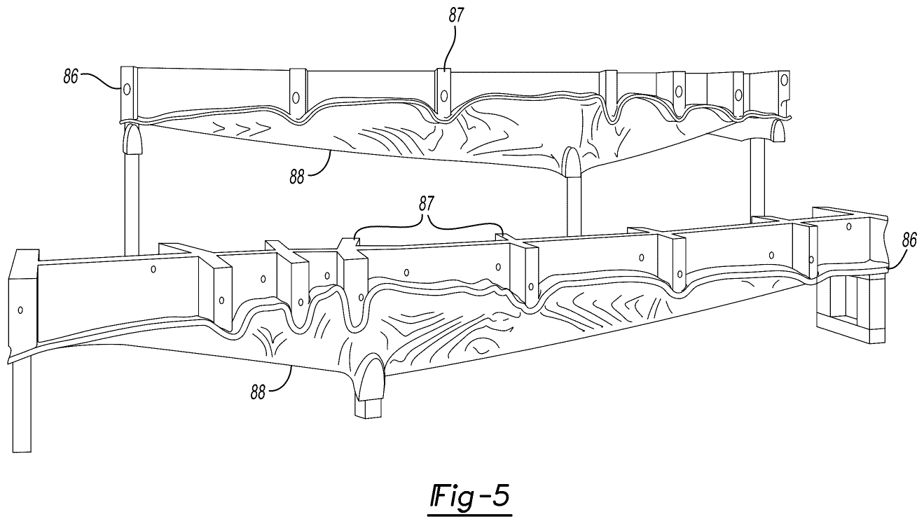

FIG. 5 shows a perspective view of cementitious components in the form of lightweight slab segments 86 with up to 75% material reduction enabled through material optimization using a rib 87 and shell concept 88. The MN-RAS methods of the present disclosure can enable the production of such slab formed with first regions of reinforced cementitious composites having rebar reinforcements for load-bearing and second distinct regions of non-load bearing carbonized cementitious compositions free of metal reinforcements in accordance with certain aspects of the present disclosure, for example, via the additive spraying processes conducted on the automated spraying device as shown and described above in FIGS. 3 and 4.

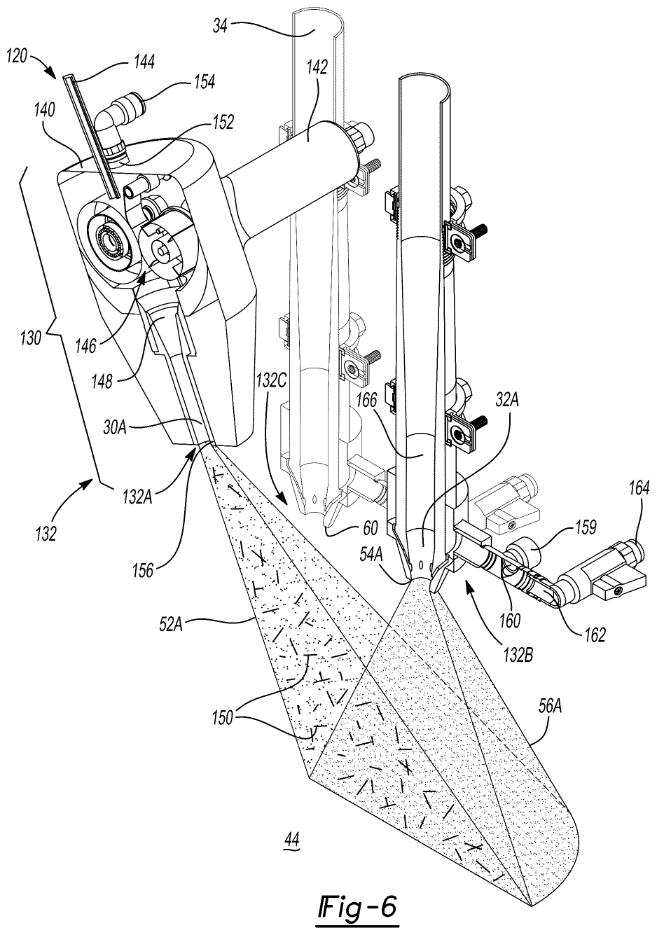

FIG. 6 shows another variation of an automated spraying device 120 prepared in accordance with certain aspects of the present disclosure. This includes a variation to the fiber feeding system. Further, additives, such as accelerator, may be introduced to the second supply line configured to deliver the sprayable cementitious material or low viscosity slurry. The device 120 comprises a feed system 130 and an automated spray system 132 and is configured to conduct an additive spraying process by concurrently generating a first sprayed stream comprising fibers, optionally from a first nozzle that is generated by a fiber chopper component and a second sprayed stream comprising a sprayable cementitious material (or any other slurry material) from a second nozzle. A third sprayed stream (not shown being formed in FIG. 6) comprising a second sprayable cementitious material comprising carbon dioxide (CO₂) generated from a third nozzle may alternatively be directed towards a target on a planar substrate. In FIG. 6, the first and second nozzles are generating a first sprayed stream and a second sprayed stream, while the third nozzle is inactive during this operational mode.

To the extent that the components of automated spraying device 120 are the same or similar in function to those in automated spraying device 20 discussed above in the context of FIGS. 1-4, they will not be reintroduced or discussed again herein for brevity. The feed system 130 includes a first supply line 30A configured to deliver fibers. The first supply line 30A includes a fiber chopper device 140. The fiber chopper 140 has a motor 142 that chops a feed fiber 144 in an internal chopping region 146 including various internal chopping rollers and components that form part of a chopping mechanism. The feed fiber 144 may be an elongated and continuous fiber that is chopped at predetermined points to generate a plurality of discrete chopped fibers 150 having a predetermined length corresponding to the chopping frequency selected by a user. This may be achieved by adjusting the configuration of the choppers in a fiber chopping region where the components of the internal chopping region 146 operate, so that one configuration results in shorter fibers whereas a second configuration results in longer fibers. In this manner, a length of the fibers may be adjusted by changing the configuration of the chopping section in the spray chopper (fiber chopper device 140) so that there are fewer chops per rotation of the rollers in the internal chopping region 146. Generally, longer fibers can result in a higher strength and stiffer material, whereas shorter fibers provide a more flexible material. As will be appreciated, the length of the chopped fibers 150 may thus be dynamically controlled during operation of the chopper device 140 to generate fibers of varying lengths. As described above, the first supply 30A may be pneumatic and in fluid communication with a pressurized gas. In this variation, the chopper device 140 also an inlet 152 that receives a pressurized gas (e.g., air) supply 154, for example, from a compressed gas source. The pressurized air from the pressurized air supply 154 and chopped fibers 150 then pass into a fiber cavity 148, where a pressurized pneumatic stream of fibers serves as the first supply 30A.

As shown, the automated spray system 132 may be divided into three separately controlled supplies (first supply line 30A is shown as part of first automated spray subsystem 132A, a second supply line 32A is shown as part of second automated spray subsystem 132B, and a third supply line 34 to third nozzle 60 is shown as part of third automated spray subsystem 132C), but each may be digitally controlled and coordinated with one another like embodiments discussed above as discussed above. The first supply line 30A may or may not have a separate nozzle, but rather may deliver first sprayed stream 52A directly from the fiber chopper device 140 at an outlet 156 that may be an orifice (or optionally having an integrated nozzle). The outlet 156 is configured to deliver the first sprayed stream 52A comprising fibers directed towards the target 44. Again, the outlet 156 of the fiber chopper device 140 may be digitally controlled.

In the automated spraying device 120, additives, such as accelerator, may be introduced to the second supply line 32A that is configured to deliver the sprayable cementitious material or low viscosity slurry. The second automated spray subsystem 132B also includes a second nozzle 54A that is in communication with the second supply line 32A and is configured to deliver a second sprayed stream 56A comprising a sprayable cementitious material directed towards the target 44. The second nozzle 54A may also be digitally controlled.

Where the sprayable slurry material is a sprayable cementitious material, for example, comprising ordinary Portland cement, the spraying of the second sprayed stream 56A may further comprise introducing an accelerator via an accelerator supply line 159 (connected to an upstream supply of accelerator or additive not shown in FIG. 6) that enters an inlet 160 of line 162. As described above, the second supply 32A may be pneumatic and in fluid communication with a pressurized gas. Thus, the line 162 receives a pressurized gas (e.g., air) supply 164, for example, from a compressed gas source. The pressurized air from the pressurized air supply 164 and accelerator 159 then pass into a slurry cavity 166 where slurry (e.g., sprayable cementitious material) is fed. In this manner, the pressurized pneumatic stream comprising accelerator combines with the sprayable cementitious material so that mixing occurs to form a pressurized slurry material that can exit the nozzle 54A and create the second supply 32A. Like the embodiment described above, the addition of the accelerator at 159 thus accelerates activation and setting of the cementitious material as it is applied to the target 44.

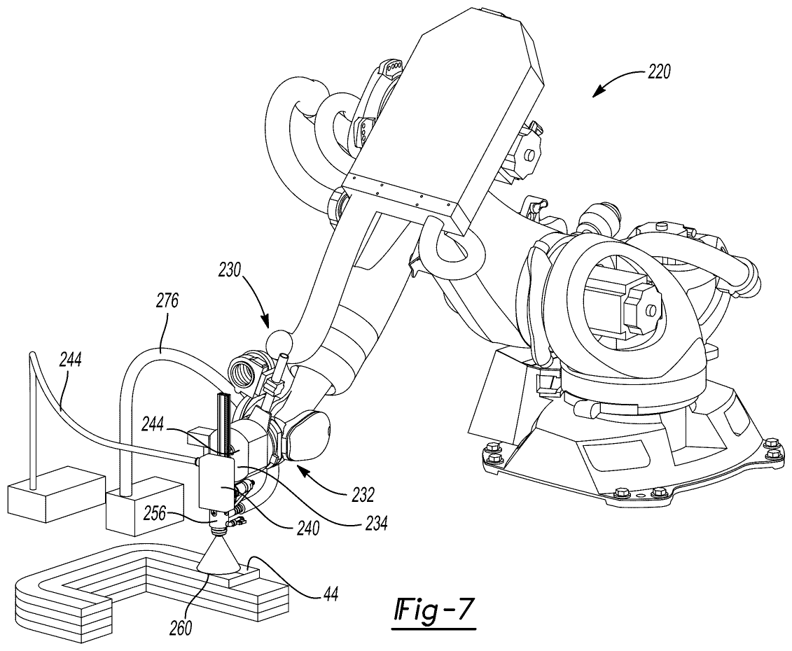

FIG. 7 shows an automated spraying device prepared in accordance with certain aspects of the present disclosure and that is configured to conduct an additive spraying process capable of generating a concentric stream from a nozzle. The concentric stream includes a central region and a surrounding concentric or peripheral region, where the central region of the nozzle sprays fibers and the peripheral region sprays a sprayable cementitious material (or any other slurry material) or a second sprayable cementitious material comprising carbon dioxide (CO₂) towards a target on a planar substrate.

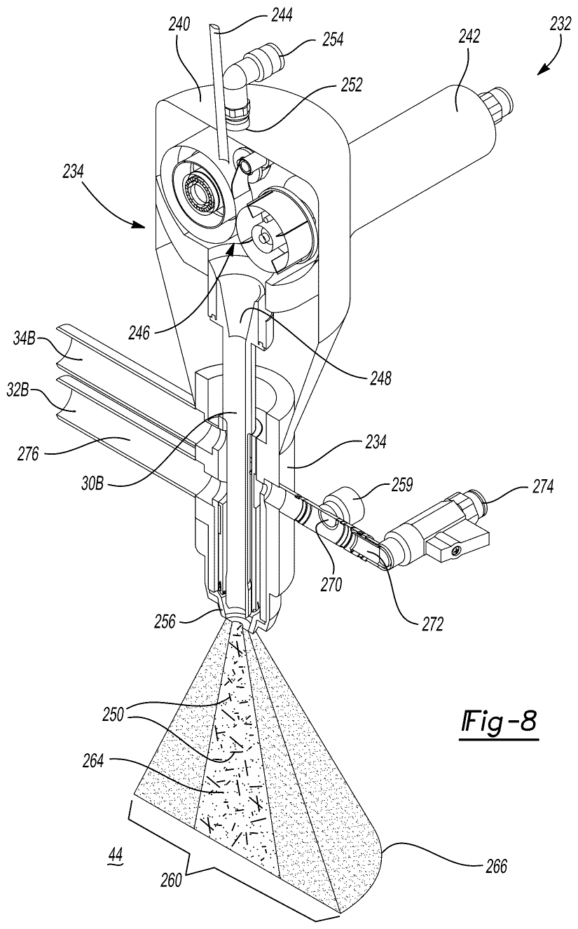

In FIG. 7, an automated spraying device 220 prepared in accordance with certain aspects of the present disclosure is configured to conduct an additive spraying process by generating the concentric stream from a nozzle that includes a central region and a surrounding peripheral region, as described further herein. Further, additives, such as accelerator, may be introduced to deliver the sprayable cementitious material or low viscosity slurry. The device 220 comprises a feed system 230 and an automated spray system 232, best shown in FIG. 8. To the extent that the components of automated spraying device 220 are the same or similar in function to those in automated spraying devices 20 and 120 discussed above in the context of FIGS. 1-4 and 6, they will not be reintroduced or discussed again herein for brevity. The automated spray system 232 includes an automated spray head 234, which is shown in more detail in FIG. 8, and may be digitally controlled as discussed above.

The feed system 230 includes a first supply line 30B configured to deliver fibers at the spray head 234. The first supply line 30B is associated with a fiber chopper device 240. The fiber chopper 240 has a motor 242 that chops an elongated feed fiber 244 into a plurality of chopped fibers 250 in an internal chopping region 246 including various internal chopping rollers and components that form part of a chopping mechanism. It will be appreciated that fiber chopper device 240 may operate in a similar manner to the fiber chopper device 140 in FIG. 6 and thus will not be discussed again herein in detail. The first supply line 30B may be pneumatic and in fluid communication with a pressurized gas. In this variation, the chopper device 240 also has an inlet 252 that receives a pressurized gas (e.g., air) supply 254, for example, from a compressed gas source. The pressurized air from the pressurized air supply 254 and chopped fibers 250 then pass into a fiber cavity 248 in fluid communication with or defining a central region of a nozzle 256.

The automated spray system 232 at the spray head 234 also includes a second supply line 32B configured to deliver the sprayable cementitious material or low viscosity slurry at nozzle 256. In the automated spraying device 220, additives, such as accelerator, may be introduced to the second supply line 32B that is configured to deliver the sprayable cementitious material or low viscosity slurry. For example, where the sprayable slurry material is a sprayable cementitious material, for example, comprising ordinary Portland cement, the spraying of a second sprayed stream 266 may further comprise introducing an accelerator via an accelerator supply line 259 (connected to an upstream supply of accelerator or additive not shown in FIGS. 7 and 8) that enters an inlet 270 of line 272. The second supply 32B may be pneumatic and in fluid communication with a pressurized gas. Thus, the line 272 receives a pressurized gas (e.g., air) supply 274, for example, from a compressed gas source. The pressurized air delivered from the pressurized air supply 274 and accelerator 259 then combine with cementitious slurry material entering from a first slurry supply line 276 that mix together into second supply line 32B where slurry (e.g., first sprayable cementitious material) is fed into the spray head 234 of the nozzle 256. In this manner, the pressurized pneumatic stream comprising accelerator combines with the sprayable cementitious material so that mixing occurs to form a pressurized slurry material that can exit the nozzle 256 in a peripheral region (a concentric shell around the core region) and create the second supply line 32B. Like the embodiment described above, the addition of the accelerator at 259 thus accelerates activation and setting of the cementitious material as it is applied to the target 44.

In certain operational modes, the nozzle 256 is configured to deliver a concentric sprayed stream 260 directed towards the target 44 that includes a first sprayed stream 264 comprising fibers 250 in a central region and a second sprayed stream 266 comprising cementitious materials/slurry in a peripheral region (or a concentric shell surrounding the first sprayed stream 264 in the central region) Thus, the two distinct sprayed streams (264, 266) combine at the nozzle 256 of the automated spray head 234 to generate a combined concentric sprayed stream 260 where the fibers and cementitious materials are mixed together as they are deposited on the target 44.

As shown in FIGS. 7 and 8, the automated spray head 234 may also receive a third supply line 34B that may provide a source of second sprayable cementitious material comprising carbon dioxide (CO₂). The slurry from the third supply line 34B may alternatively be fed into the peripheral region of the nozzle 256 in lieu of the second supply 32B. The second sprayable cementitious material comprising carbon dioxide (CO₂) may also be pneumatic and pressurized by combining it with a pressurized gas delivered from line 272 and pressurized gas supply 274. Further, the accelerator 259 may or may not be used when the second sprayable cementitious material comprising carbon dioxide (CO₂) is being delivered at the spray head 234 and nozzle 256. Further, in certain variations or operational modes, only the second sprayable cementitious material comprising carbon dioxide (CO₂) is delivered from third supply line 34B to the nozzle 256, while there are no fibers being generated by the chopper device 240 and no first cementitious material being delivered via second supply 32B. Thus, material may only flow through a peripheral region of nozzle 256 and thus only generate a second sprayed stream 266, while no first sprayed stream 264 is present in such asn operational mode where the second sprayable cementitious material comprising carbon dioxide (CO₂) is being deposited on the target 44. In other variations, the second sprayable cementitious material comprising carbon dioxide (CO₂) may be co-sprayed with the fiber chopper device 240 operational, so that both the first and second sprayed streams 264 and 266 are generated as a concentric sprayed stream 260 (thus adding a reinforcement of fibers into the second sprayable cementitious material comprising carbon dioxide (CO₂).

As discussed above, the first and second sprayable compositions for additive manufacturing/spraying have a fresh state, where the composition may be in a liquid or semi-liquid phase and thus sprayable for the additive manufacturing spraying process. As noted above, in certain variations, both the first and second sprayable compositions are cementitious compositions. The properties of such a sprayable cementitious composition in a fresh state include sprayability, while after hydraulic setting and reaction proceeds; the cementitious composition is in a hardened state. In various aspects, each of the sprayable cementitious compositions comprises a cementitious material, which may include a cement or pozzolan. In certain variations, such a cementitious composition comprises Portland cement, an aggregate, such as a fine aggregate, water, and other typical ingredients known to those of skill in the art for sprayable cementitious compositions, such as fly ash, plasticizers, accelerators, and the like.

In alternative aspects, the present technology may include forming a first fiber-reinforced composition where the slurry that is sprayed may include clay, earth-based materials, starch, and the like. The material has a viscosity such that it can be pumped and within a material atomization range when being sprayed. A reinforced composite material is thus formed with a slurry precursor having low viscosity that is both pumpable and sprayable. Further, an accelerator may be added at the spraying nozzle or after spraying to allow for an on-demand setting.

A Portland cement typically comprises inorganic compounds, such as dicalcium silicate (C₂S or 2CaO·SiO₂), tricalcium silicate (C₃S or 3CaO·SiO₂), tricalcium aluminate (C₃A or 3CaO·Al₂O₃), and tetracalcium aluminoferrite (C₄AF or 4CaO·Al₂O₃·Fe₂O₃), which may be hydrated. Commercially available Portland cement often includes additives, such as gypsum (calcium sulfate) that serves as a set retardant, and pozzolans, like fly ash and ground granulated blast furnace slags (GGBFS), that can react with calcium hydroxide and water to form calcium silicate hydrates or calcium aluminate hydrates. When pozzolans are added to Portland cement, they are considered blended cements. ASTM, International Test C 150 called the “Standard Specification for Portland Cement” provides eight types of ordinary Portland cement for different applications, namely: Types I, IA, II, IIA, III, IIIA, IV, and V. In certain non-limiting aspects, the Portland cement used in the cementitious composition is Type I. The Portland cement may be present in the cementitious composition at greater than or equal to about 50 mass/weight % to less than or equal to about 98 mass % of the total mass of cementitious binder components, optionally at greater than or equal to about 60 mass/weight % to less than or equal to about 90 mass % of the total mass of cementitious binder components, and in certain variations, optionally at about 72% by mass of the total mass of the cementitious binder components.

In certain variations, the sprayable cementitious composition may further comprise a fly ash that can be added to the cementitious composition and serves as a pozzolan/cementitious material. Fly ash is an industrial byproduct, for example, collected from effluent of a coal burning boiler unit. It can be used as a substitute for a portion of the Portland cement to reduce energy consumption required to form the overall product and increase the environmental friendliness of the cementitious composition, while contributing to the cementitious properties of the matrix/binder system of the concrete composite. In one variation, the fly ash may be a Class F fly ash as designated by ASTM C618, which is formed from combustion of anthracite and/or bituminous coals. ASTM C618 requires that Class F fly ash contain at least 70% pozzolanic compounds (silica oxide, alumina oxide, and iron oxide). The fly ash may be present in the cementitious composition at 0 mass/weight % to less than or equal to about 45 mass % of the total mass of cementitious binder components, optionally at 0 mass % to less than or equal to about 35 mass % of the total mass of cementitious binder components, an in certain aspects, optionally at about 23 mass % of the total mass of cementitious binder components. In other aspects, the fly ash may be present in the cementitious composition at 0 mass % to less than or equal to about 25 mass % of the total cementitious composition.

The sprayable cementitious composition may also include a fine aggregate, such as an inert sand or inert finely crushed stone. Fine aggregates may have a particle size distribution having approximately 95% passing on a 9.5 mm sieve (⅜ inch sieve). In certain variations, the fine aggregate is sand. The solid aggregate is distributed within the cementitious matrix to form a composite. In certain variations, the aggregate may be substantially homogeneously distributed within the cementitious composite (e.g., concrete) that is formed. The fine aggregate may comprise sand that has an average particle size of less than or equal to about 2 mm. In one non-limiting variation, the aggregate may be an F-75 silica or quartz sand commercially available from U.S. Silica. The fine aggregate may be present in the cementitious composition at greater than or equal to about 20 mass/weight % to less than or equal to about 65 mass % of the total mass of cementitious binder components, optionally at greater than or equal to about 30 mass/weight % to less than or equal to about 60 mass % of the total mass of cementitious binder components, and in certain variations, optionally at about 45 mass % of the total mass of cementitious binder components.

The cementitious composition also includes a high range water reducing agent (HRWRA), also known as a plasticizer/superplasticizer. Inclusion of the HRWRA can serve to reduce water content needed in the cementitious composition by about 10% to about 30%. The HRWRA can create high fluidity with good flowability properties for the sprayable cementitious composition, contributing to making the cementitious composition suitable for spraying via additive manufacturing by helping to eliminate the need for any vibration or compaction after deposition. An example of a suitable HRWRA is a low viscosity polycarboxylate based high-range water-reducing admixture commercially available from W. R. Grace as ADVA® 190. The HRWRA may be present in the cementitious composition at greater than or equal to about 0.3 mass/weight % to less than or equal to about 1.5 mass % of the total mass of cementitious binder components.

Water is also included in the sprayable cementitious composition. A mass ratio of water to cementitious binder components (e.g., Portland cement, and any other pozzolanic materials, like fly ash) may be greater than or equal to about 0.2 to less than or equal to about 0.55. In one variation, a mass ratio of water to cementitious binder components is about 0.43. Water temperature can be used intentionally to manipulate the fresh state properties of a particular cementitious material composition. Water temperature affects fresh state rheological properties due to the accelerated activation of pozzolanic reactions of the cementitious materials. Water may be present in the cementitious composition at greater than or equal to about 10 mass % to less than or equal to about 35 mass % of the total cementitious composition. In one variation, the water may be present at about 20 to about 21% by mass of the total composition (e.g., about 20.7%).

The second sprayable cementitious material may comprise any of the components described above, but also further comprises added carbon dioxide (CO₂). CO₂-infused concrete is a carbon-capture method, where CO₂ is integrated into cementitious material during mixing and can thus form calcium carbonate during the curing process, which permanently retains carbon within the concrete component formed after the cementitious composition undergoes curing. Portland cement-based systems have typically demonstrated a capability of chemically trapping CO₂ at less than about 20 weight % (for example from about 5 to about 20 weight %). This process, also known as carbonation, forms a carbonized cementitious material. Carbonation can promote chemical stability and enhance material durability when exposed to a variety of aggressive environments. Nevertheless, the alkaline environment created by Portland cement hydration is neutralized during the carbonation process, which substantially raises the risk of corrosion for conventional reinforced concrete. As noted above, when the second sprayable cementitious material comprising carbon dioxide (CO₂) is used in certain regions of the cementitious structural component, they are preferably free of metal reinforcements, such as steel rebar, to avoid such corrosion. The carbon dioxide may be injected, diffused, or otherwise introduced into fresh cementitious material and then mixed with the other components to form the second sprayable cementitious material comprising CO₂.

As discussed above, at least one region of the cementitious structural component may be a fiber-reinforced cementitious composite structure that comprises at least one type of fiber distributed within the cementitious matrix to form a composite (in combination with the aggregate solid material). While fibers are preferably mixed with the first sprayable cementitious composition in certain variations, they may also be mixed with the second sprayable cementitious material, as well.

For example, the methods of additive spraying of a first or second cementitious material may comprise spraying a first stream comprising a reinforcement phase or material, such as fibers, from a first nozzle on an automated spray head towards a target. The method also comprises spraying a second stream comprising a first sprayable cementitious material from a second nozzle on the automated spray head towards the target or alternatively spraying a third stream comprising a second sprayable cementitious material (comprising carbon dioxide) from a third nozzle on the automated spray head towards the target. In this manner, a first sprayed layer of reinforced cementitious composite is formed from the combined first stream and the second stream on the target or a second sprayed layer of reinforced cementitious composite is formed from the combined first stream and the third stream on the target.

In certain aspects, the methods may comprise concurrently spraying the first stream and the second stream or alternatively the third stream towards the target. The first stream and the second stream or alternatively the third stream may at least partially combine prior to hitting the target. In other aspects, the first stream and second stream or alternatively the third stream may be directed in a manner such that their combination and mixing occurs on the target itself. In other variations, the methods may comprise successively spraying the first stream and then the second stream or alternatively the third stream towards the target, thus forming a first layer from the first stream and a second layer over the first layer formed by the second stream or alternatively the third stream.

In certain variations, the plurality of fibers may be substantially homogeneously distributed within the cementitious composite (e.g., concrete) that is formed. In certain aspects, the fibers may have a single composition or may include a mixture of different compositions or other combinations of select properties, such as different lengths or diameters. The fibers may include a variety of distinct materials, such as carbon fibers, glass (e.g., fiberglass, quartz, silica, borosilicates, etc.), polymer fibers (e.g., polyvinyl alcohol (PVA) or polyalkylene fibers, such as polyethylene (PE) or polypropylene (PP), including high tenacity polypropylene (HTPP) fibers), aramid fibers (such as KEVLAR™ para-aramid synthetic fibers and TWARON™ para-aramid synthetic fibers)), basalt fibers, boron fibers, ceramic fibers, natural fibers, including plant-based fibers (derived from plants) and animal-based fibers (derived from animals), such as sisal, jute, hemp, bamboo, curaua fibers, cellulose-based fibers, goat hair, and the like, artificial fibers, and any combination thereof.

An aspect ratio or ratio between a length of the fiber (L) and a diameter (D) of the fiber (AR=L/D) may be greater than or equal to about 150. In certain variations, the AR may be greater than or equal to about 150 to less than or equal to about 900.

In certain variations, a suitable fiber may have a length of greater than or equal to about 4 mm to less than or equal to about 20 mm, optionally greater than or equal to about 6 mm to less than or equal to about 15 mm, optionally greater than or equal to about 8 mm to less than or equal to about 12 mm, and in certain variations, optionally greater than or equal to about 8 mm to less than or equal to about 10 mm. In certain variations, a fiber in the fiber-reinforced cementitious composite structure has a diameter of greater than or equal to about 10 micrometers (μm) to less than or equal to about 200 μm. In one variation, the fiber is a glass fiber. In another variation, the fiber is a carbon fiber. The fiber may be present in the fiber-reinforced cementitious composite structure at greater than or equal to about 1 vol. % to less than or equal to about 4.5 vol. % of the total volume of the fiber-reinforced cementitious composite structure, optionally at greater than or equal to about 1.8 vol. % to less than or equal to about 4 vol. %, and in certain variations, optionally at about 2 vol. %.

The robotic additive spraying devices can thus be used to spray the fiber and sprayable cementitious material (the first sprayable cementitious material or the second sprayable cementitious material comprising carbon dioxide (CO₂)) from select nozzles of the three or more separate numerically controlled nozzles in a sprayed layer to fabricate three-dimensional structural concrete elements. The RAS technology is adaptable to almost any feedstock materials including, but not limited to fibers, and may include other reinforcement materials, such as particles. Thus, the inventive technology may be used to form a multitude of composite materials and can apply to a variety of industries beyond concrete construction. The RAS technology is adaptable to almost any feedstock materials and may thus be used to spray earth, clays, silicas, geo-polymers, liquid-polymers, bio-hemp, wood or metal fibers, by way of non-limiting example at small or large scales applicable to various industries, including construction, aerospace, automobile, and defense, by way of non-limiting example.

In certain variations, the methods may comprise controlling and modifying a concentration of fibers present in the regions of reinforced cementitious composite material formed over the target. For example, the spraying of the first stream may occur at a first flow rate for a first duration so that the fibers are present at a first concentration in the reinforced cementitious composite. The method may then further comprise adjusting the spraying of the first stream to a second flow rate distinct from the first flow rate for a second duration so that the fibers are present at a second concentration distinct from the first concentration in the reinforced cementitious composite. This adjustment of fiber concentration may be done in a single sprayed layer or interspersed in different sprayed layers (where each layer may have a different concentration of fibers in the reinforced cementitious composite). Notably, the flow rates may be adjusted as needed and are not limited to only two flow rates, but may be highly variable, for example, adding higher concentrations of fibers for reinforcement in high stress areas of a structure, while providing lower concentrations of fibers in areas of a structure experiencing lower potential stress in service. In this manner, the methods of the present disclosure contemplate tailoring volume fraction fiber (VFF) in the reinforced cementitious composite and thus enables functional grading of the tensile property of the material.

The methods include repeating the spraying of the first stream and the second stream or alternatively the third stream and forming at least one additional sprayed layer of reinforced cementitious composite over the first layer that is disposed on the target. In this manner, a physical structure can be built in a flexible, automated, layer-by-layer additive manufacturing process without requiring traditional reinforcements (e.g., rebar) or extrusion.

As noted above, where a fourth stream is generated by a fourth nozzle present on the automated spray head, the methods may comprise controlling and modifying a concentration of aggregate or solid particles present in the reinforced cementitious composite material formed over the target.

In certain variations, the methods provided by the present disclosure may be referred to as Robotic Additive Spraying (RAS). The present disclosure thus contemplates methods of Multi-Nozzle (MN) Robotic Additive Spraying (RAS or MN-RAS) that are an alternative to extrusion-based 3D printing. The MN-RAS provides a robotically controlled manufacturing process using compressed gases, like compressed air, to spray various materials from independent nozzles under pressure to fabricate concrete structures in layers and can overcome traditional challenges such as better interlayer bonding due to the high kinetic energy associated with pressurized material deposition in RAS. Here the material may be shot against the preceding layer with digitally controlled kinetic energy to produce a strong interlayer bond without the need for adhesive or accelerators. In certain variations, fiber-reinforced CO₂ infused concrete can be formed where the MN-RAS process and system uses three separate nozzles to alternate between conventional concrete in load-bearing areas where rebar reinforcement is necessary, and CO₂-infused concrete mixes in regions without rebar to avoid carbonized concrete promoting corrosion of rebars. Further, fibers like carbon and glass fibers can be sprayed concurrently with either concrete solution for the enhanced tensile properties.

Because RAS deposits carbon/glass fiber with wet mortar in successive layers from separate nozzles, it enables on-demand modulation of fiber amount (for example, tailoring volume fraction fiber (VFF)) and thus enables functional grading of the tensile property. As such, the MN-RAS employing a robotically controlled manufacturing process using compressed gas/air to spray various materials at high kinetic energy from independent nozzles, fiber-reinforced concrete structures with improved interlayer bonding are produced. In certain variations, the present disclosure enables high atomization spraying that enables superior fiber-mortar integration and buildability with no shrinkage, material buildability while ensuring structural integrity, and applicability of the process to other mortars and fibers.

In various aspects, the present technology can provide one or more of the following benefits: (1) significantly reduce or eliminate the “cold joint” problem between layers, increase vertical interlayer and horizontal filament bonding strength and ductility by at least 80%, and thus structural stability for both lateral and tensile loads; (2) significantly reduce shrinkage cracking of 3D printed concrete as result of integration of higher fiber content with pressure and functional grading; (3) significantly reduce the need for traditional continuous reinforcement, which is generally incompatible with complex topology optimized geometries via tailored functional grading of fiber content; (4) enable the creation of new civil infrastructure composite components and structures with multifunctional and functionally graded properties; (5) increase sustainability in the concrete construction industry. This increased sustainability may occur by a) eliminating concrete waste by placing material only where it is needed, as well as eliminating the need for formwork, b) enabling structural designs with superior mechanical performance and durability, reducing maintenance energy, and c) integrating carbon-capture technology in the form of CO₂-infused concrete.

In this manner, the MN-RAS process can significantly minimize the carbon footprint of concrete construction by enabling materially optimized design of concrete structures minimizing waste and energy consumption, in addition to incorporating of carbon-capture technology in the form of CO₂-infused concrete.

The MN-RAS processes provided by various aspects of the present disclosure enable a reduction of the relatively vast CO₂ footprint of concrete construction, first by eliminating waste via materially optimized design of concrete parts and second by integration of carbon-capture technology, such as CO₂-infused concrete.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An automated spraying device for additive manufacturing, the device comprising:
a feed system comprising a first supply line configured to deliver fibers, a second supply line configured to deliver a first sprayable cementitious material, a third supply line configured to deliver a second sprayable cementitious material comprising carbon dioxide (CO₂); and
an automated spray head that comprises:
a first nozzle in communication with the first supply line, the first nozzle configured to deliver a first sprayed stream comprising fibers;
a second nozzle in communication with the second supply line and configured to deliver a second sprayed stream comprising the first sprayable cementitious material; and
a third nozzle in communication with the third supply line and configured to deliver a third sprayed stream comprising the second sprayable cementitious material comprising carbon dioxide (CO₂), wherein the automated spraying system is configured to form a cementitious component on a target, the cementitious component has a first region comprising a reinforced cementitious composite material formed from the first sprayed stream comprising fibers from the first nozzle and the second sprayed stream comprising the first sprayable cementitious material and a second distinct region comprising a carbonized cementitious material formed from the third sprayed stream comprising the second sprayable cementitious material comprising carbon dioxide (CO₂).

2. The automated spraying device of claim 1, wherein the second distinct region comprising the carbonized cementitious material is formed from the first sprayed stream comprising fibers from the first nozzle and the third sprayed stream comprising the second sprayable cementitious material comprising carbon dioxide (CO₂).

3-4. (canceled)

5. The automated spraying device of claim 1, wherein the automated spray head is disposed on at least one robotic device or a computer numerical control (CNC) gantry and each of the first nozzle, the second nozzle, and the third nozzle are at least partially controlled individually by a computer numerical control (CNC) system.

6-7. (canceled)

8. The automated spraying device of claim 1, wherein the first nozzle and the third nozzle are adjacent to one another on the automated spray head and the second nozzle is disposed at a predetermined distance away from the first nozzle and the third nozzle on the automated spray head.

9. The automated spraying device of claim 1, wherein the first sprayed stream is a first pneumatically sprayed stream and the first supply line is pressurized and in fluid communication with a first compressed gas source, the second sprayed stream is a second pneumatically sprayed stream and the second supply line is pressurized and in fluid communication with a second compressed gas source, and the third sprayed stream is a third pneumatically sprayed stream and the third supply line is pressurized and in fluid communication with a third compressed gas source.

10. The automated spraying device of claim 1, wherein the fibers are selected from the group consisting of: glass fibers, carbon fibers, plant-based fibers, animal-based fibers, and combinations thereof and the first sprayable cementitious material comprises a Portland cement, a fine aggregate, and water.

11. The automated spraying device of claim 1, wherein the automated spraying device is configured to combine the first sprayed stream comprising fibers from the first nozzle and the second sprayed stream comprising the first sprayable cementitious material as a combined stream for deposition onto the target to the reinforced cementitious composite material in the first region.

12. The automated spraying device of claim 1, wherein the automated spray head further comprises a fourth nozzle in communication with a fourth supply line, wherein the fourth nozzle is configured to deliver a fourth sprayed stream comprising solid particles.

13. The automated spraying device of claim 1, wherein the feed system further comprises a fiber chopper that comprises a motor configured to chop a feed fiber into the fibers delivered in the first supply line to the first nozzle.

14. A method of additive spraying of a cementitious material, the method comprising:
spraying a first stream comprising fibers from a first nozzle on an automated spray head towards a target;
spraying a second stream comprising a first sprayable cementitious material from a second nozzle on the automated spray head towards the target; and
forming a first region of a cementitious component on the target having a reinforced cementitious composite formed by the first stream and the second stream; and
spraying a third stream comprising a second sprayable cementitious material comprising carbon dioxide (CO₂) from a third nozzle on the automated spray head towards the target to form a second distinct region of the cementitious component on the target formed by the third stream and comprising a carbonized cementitious material.

15. The method of claim 14, wherein the spraying the first stream and the spraying of the second stream forms a first sprayed layer in the first region and the method further comprises repeating the spraying of the first stream and the second stream and forming at least one additional sprayed layer of reinforced cementitious composite over the first sprayed layer.

16. The method of claim 14, wherein the spraying the first stream and the second stream towards the target occur concurrently and the first stream and the second stream combine together and are deposited on the target as a combined stream.

17. (canceled)

18. The method of claim 14, wherein the spraying the first stream and the second stream towards the target occur sequentially to one another.

19. The method of claim 14, wherein the spraying the first stream occurs at a first flow rate for a first duration so that the fibers are present at a first concentration in the first region of the reinforced cementitious composite and the method further comprises adjusting the spraying of the first stream to a second flow rate distinct from the first flow rate for a second duration so that the fibers are present at a second concentration distinct from the first concentration in the first region of the reinforced cementitious composite.

20. The method of claim 14, wherein the fibers are selected from the group consisting of: glass fibers, carbon fibers, plant-based fibers, animal-based fibers, and combinations thereof and the first sprayable cementitious material comprises a Portland cement, a fine aggregate, and water.

21. The method of claim 14, wherein the second distinct region of the cementitious component comprising the carbonized cementitious material is formed by the spraying of the third stream and concurrently spraying of the first stream comprising fibers.

22-23. (canceled)

24. The method of claim 14, further comprising spraying a fourth stream comprising solid particles from a fourth nozzle on the automated spray head towards the target, wherein the forming of the first region of reinforced composite material comprises combining the first stream, the second stream, and the fourth stream on the target.

25-27. (canceled)

28. The method of claim 14, further comprising chopping a feed fiber into the fibers prior to the spraying the first stream comprising the fibers.

29. An automated spraying device for additive manufacturing, the device comprising:
a feed system comprising a first supply configured to deliver fibers, a second supply configured to deliver a first sprayable cementitious material, and a third supply configured to deliver a second sprayable cementitious material comprising carbon dioxide (CO₂); and
an automated spray head that comprises at least one nozzle in communication with the first supply, the second supply, and/or the third supply, wherein the at least one nozzle is configured to deliver at least one sprayed stream comprising the fibers, the first sprayable cementitious material, and/or the second sprayable cementitious material, wherein the automated spraying system is configured to form a cementitious component on a target, the cementitious component has a first region comprising a reinforced cementitious composite material formed from the first sprayed stream comprising fibers and the second sprayed stream comprising the first sprayable cementitious material and a second distinct region comprising a carbonized cementitious material formed from the third sprayed stream comprising the second sprayable cementitious material comprising carbon dioxide (CO₂).

30. The automated spraying device of claim 29, wherein the at least one nozzle includes a first nozzle, a second nozzle, and a third nozzle and the automated spray head comprises the first nozzle in communication with the first supply, the first nozzle configured to deliver a first sprayed stream comprising fibers;
the second nozzle in communication with the second supply and configured to deliver a second sprayed stream comprising the first sprayable cementitious material; and
the third nozzle in communication with the third supply and configured to deliver a third sprayed stream comprising the second sprayable cementitious material comprising carbon dioxide (CO₂), wherein the at least one sprayed stream further comprises a first sprayed stream, a second sprayed stream, and a third sprayed stream, wherein the first nozzle is configured to deliver the first sprayed stream comprising fibers, the second nozzle is configured to deliver the second sprayed stream comprising the first sprayable cementitious material, and the third nozzle is configured to deliver the third sprayed stream comprising the second sprayable cementitious material comprising carbon dioxide (CO₂), wherein the cementitious component has the first region comprising a reinforced cementitious composite material formed from the first sprayed stream comprising fibers from the first nozzle and the second sprayed stream comprising the first sprayable cementitious material and the second distinct region comprising a carbonized cementitious material formed from the third sprayed stream comprising the second sprayable cementitious material comprising carbon dioxide (CO₂).

31-59. (canceled)
